(19) United States
(12) Patent Application Publication
(10) Pub. No.: US 2020/0396619 A1
(43) Pub. Date: Dec. 17, 2020

(54) METHOD AND APPARATUS FOR ENHANCING MEASUREMENT RULE ON UNLICENSED FREQUENCY IN WIRELESS COMMUNICATION SYSTEM

(71) Applicant: LG ELECTRONICS INC., Seoul (KR)

(72) Inventor: Sangwon Kim, Seoul (KR)

(21) Appl. No.: 16/977,727

(22) PCT Filed: May 2, 2019
(86) PCT No.: PCT/KR2019/005248

§ 371 Date: Sep. 2, 2020

(30) Foreign Application Priority Data
May 4, 2018 (KR) 10-2018-0051969

(51) Int. Cl. H04W 16/14; H04W 24/10; H04W 36/00

(52) U.S. Cl. CPC H04W 16/14; H04W 36/0085; H04W 24/10

(57) ABSTRACT

A method and apparatus for enhancing a measurement rule on an unlicensed frequency in a wireless communication system is provided. A wireless device performs measurements of neighbor cells when a channel occupancy of the unlicensed carrier is above a second threshold, even though a quality of a serving cell on the unlicensed carrier is above a first threshold (i.e. s-measure).

### TECHNICAL FIELD

The present invention relates to wireless communications, and more particularly, to a method and apparatus for enhancing a measurement rule on an unlicensed frequency in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

Carrier aggregation with at least one secondary cell (SCell) operating in the unlicensed spectrum is referred to as licensed-assisted access (LAA). In LAA, the configured set of serving cells for a UE therefore always includes at least one SCell operating in the unlicensed spectrum according to frame structure Type 3, also called LAA SCell. Unless otherwise specified, LAA SCells act as regular SCells.

LAA eNodeB (eNB) and user equipment (UE) apply listen-before-talk (LBT) before performing a transmission on LAA SCell. When LBT is applied, the transmitter listens to/senses the channel to determine whether the channel is free or busy. If the channel is determined to be free, the transmitter may perform the transmission. Otherwise, it does not perform the transmission. If an LAA eNB uses channel access signals of other technologies for the purpose of LAA channel access, it shall continue to meet the LAA maximum energy detection threshold requirement.

### SUMMARY

NR standalone operation on unlicensed bands is being discussed. Therefore, a method for supporting NR standalone operation on unlicensed bands efficiently is required. Specifically, since a cell on the unlicensed bands can be configured as a primary cell (PCell) in the NR standalone operation, measurement rules should be enhanced by considering a channel occupancy of the unlicensed bands.

In an aspect, a method performed by a wireless device in a wireless communication system is provided. The method includes determining that a quality of a serving cell on an unlicensed carrier is above a first threshold, and performing measurements of neighbor cells when a channel occupancy of the unlicensed carrier is above a second threshold.

In another aspect, a wireless device in a wireless communication system is provided. The wireless device includes a memory, a transceiver, and a processor, operably coupled to the memory and the transceiver, and configured to determine that a quality of a serving cell on an unlicensed carrier is above a first threshold, and perform measurements of neighbor cells when a channel occupancy of the unlicensed carrier is above a second threshold.

In another aspect, a processor for a wireless device in a wireless communication system is provided. The processor is configured to determine that a quality of a serving cell on an unlicensed carrier is above a first threshold, and perform measurements of neighbor cells when a channel occupancy of the unlicensed carrier is above a second threshold.

Even though a primary cell on an unlicensed frequency has good quality, if a channel occupancy of the unlicensed frequency is above a threshold, the UE can perform neighbor cell measurements.

### BRIEF DESCRIPTION OF THE DRAWINGS

FIG. 1 shows an example of a wireless communication system to which the technical features of the present invention can be applied.

FIG. 2 shows another example of a wireless communication system to which the technical features of the present invention can be applied.

FIG. 3 shows a block diagram of a user plane protocol stack to which the technical features of the present invention can be applied.

FIG. 4 shows a block diagram of a control plane protocol stack to which the technical features of the present invention can be applied.

FIG. 5 shows examples of 5G usage scenarios to which the technical features of the present invention can be applied.

FIG. 6 shows an example of a wireless communication system to which the technical features of the present invention can be applied.

FIG. 7 shows an example of a method for enhancing a measurement rule according to an embodiment of the present invention.

FIG. 8 shows a UE to implement an embodiment of the present invention.

### DETAILED DESCRIPTION

The technical features described below may be used by a communication standard by the 3rd generation partnership project (3GPP) standardization organization, a communication standard by the institute of electrical and electronics engineers (IEEE), etc. For example, the communication standards by the 3GPP standardization organization include long-term evolution (LTE) and/or evolution of LTE systems. The evolution of LTE systems includes LTE-advanced (LTE-A), LTE-A Pro, and/or 5G new radio (NR). The communication standard by the IEEE standardization organization includes a wireless local area network (WLAN) system such as IEEE 802.11a/b/g/n/ac/ax. The above system uses various multiple access technologies such as orthogonal frequency division multiple access (OFDMA) and/or single carrier frequency division multiple access (SC-FDMA) for downlink (DL) and/or uplink (DL). For example, only OFDMA may be used for DL and only SC-FDMA may be used for UL. Alternatively, OFDMA and SC-FDMA may be used for DL and/or UL.

In this document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A, B, C” may mean “at least one of A, B, and/or C.”

Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

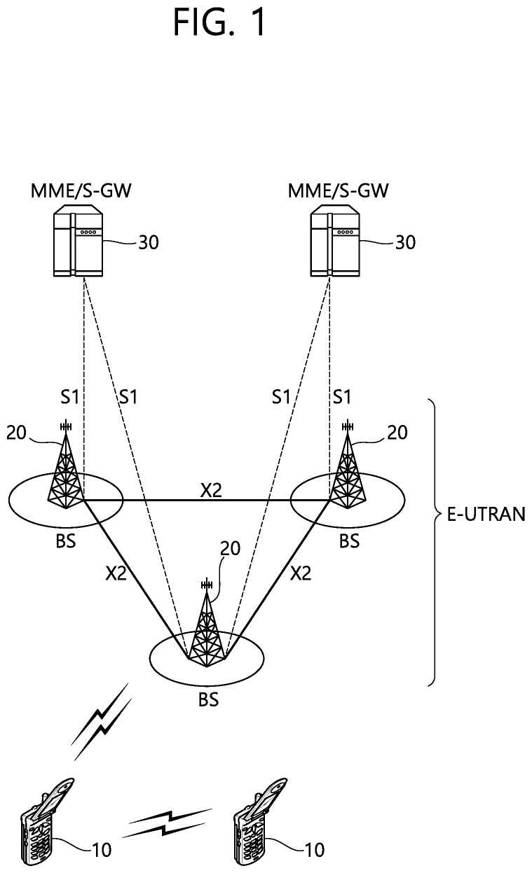

FIG. 1 shows an example of a wireless communication system to which the technical features of the present invention can be applied. Specifically, FIG. 1 shows a system architecture based on an evolved-UMTS terrestrial radio access network (E-UTRAN). The aforementioned LTE is a part of an evolved-UTMS (e-UMTS) using the E-UTRAN.

Referring to FIG. 1, the wireless communication system includes one or more user equipment (UE; 10), an E-UTRAN and an evolved packet core (EPC). The UE 10 refers to a communication equipment carried by a user. The UE 10 may be fixed or mobile. The UE 10 may be referred to as another terminology, such as a mobile station (MS), a user terminal (UT), a subscriber station (SS), a wireless device, etc.

The E-UTRAN consists of one or more base station (BS) 20. The BS 20 provides the E-UTRA user plane and control plane protocol terminations towards the UE 10. The BS 20 is generally a fixed station that communicates with the UE 10. The BS 20 hosts the functions, such as inter-cell radio resource management (MME), radio bearer (RB) control, connection mobility control, radio admission control, measurement configuration/provision, dynamic resource allocation (scheduler), etc. The BS may be referred to as another terminology, such as an evolved NodeB (eNB), a base transceiver system (BTS), an access point (AP), etc.

A downlink (DL) denotes communication from the BS 20 to the UE 10. An uplink (UL) denotes communication from the UE 10 to the BS 20. A sidelink (SL) denotes communication between the UEs 10. In the DL, a transmitter may be a part of the BS 20, and a receiver may be a part of the UE 10. In the UL, the transmitter may be a part of the UE 10, and the receiver may be a part of the BS 20. In the SL, the transmitter and receiver may be a part of the UE 10.

The EPC includes a mobility management entity (MME), a serving gateway (S-GW) and a packet data network (PDN) gateway (P-GW). The MME hosts the functions, such as non-access stratum (NAS) security, idle state mobility handling, evolved packet system (EPS) bearer control, etc. The S-GW hosts the functions, such as mobility anchoring, etc. The S-GW is a gateway having an E-UTRAN as an endpoint. For convenience, MME/S-GW 30 will be referred to herein simply as a “gateway,” but it is understood that this entity includes both the MME and S-GW. The P-GW hosts the functions, such as UE Internet protocol (IP) address allocation, packet filtering, etc. The P-GW is a gateway having a PDN as an endpoint. The P-GW is connected to an external network.

The UE 10 is connected to the BS 20 by means of the Uu interface. The UEs 10 are interconnected with each other by means of the PC5 interface. The BSs 20 are interconnected with each other by means of the X2 interface. The BSs 20 are also connected by means of the S1 interface to the EPC, more specifically to the MME by means of the S1-MME interface and to the S-GW by means of the S1-U interface. The S1 interface supports a many-to-many relation between MMEs/S-GWs and BSs.

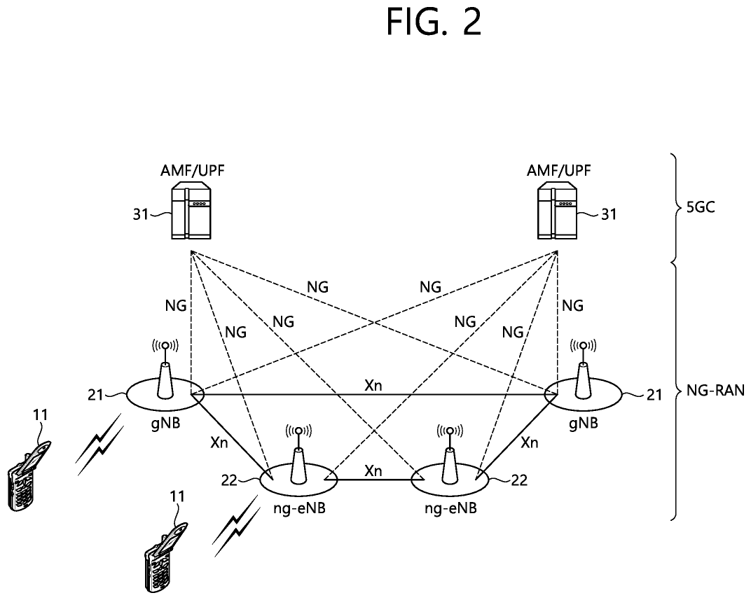

FIG. 2 shows another example of a wireless communication system to which the technical features of the present invention can be applied. Specifically, FIG. 2 shows a system architecture based on a 5G new radio access technology (NR) system. The entity used in the 5G NR system (hereinafter, simply referred to as “NR”) may absorb some or all of the functions of the entities introduced in FIG. 1 (e.g. eNB, MME, S-GW). The entity used in the NR system may be identified by the name “NG” for distinction from the LTE/LTE-A.

Referring to FIG. 2, the wireless communication system includes one or more UE 11, a next-generation RAN (NG-RAN) and a 5th generation core network (5GC). The NG-RAN consists of at least one NG-RAN node. The NG-RAN node is an entity corresponding to the BS 10 shown in FIG. 1. The NG-RAN node consists of at least one gNB 21 and/or at least one ng-eNB 22. The gNB 21 provides NR user plane and control plane protocol terminations towards the UE 11. The ng-eNB 22 provides E-UTRA user plane and control plane protocol terminations towards the UE 11.

The 5GC includes an access and mobility management function (AMF), a user plane function (UPF) and a session management function (SMF). The AMF hosts the functions, such as NAS security, idle state mobility handling, etc. The AMF is an entity including the functions of the conventional MME. The UPF hosts the functions, such as mobility anchoring, protocol data unit (PDU) handling. The UPF an entity including the functions of the conventional S-GW. The SMF hosts the functions, such as UE IP address allocation, PDU session control.

The gNBs and ng-eNBs are interconnected with each other by means of the Xn interface. The gNBs and ng-eNBs are also connected by means of the NG interfaces to the 5GC, more specifically to the AMF by means of the NG-C interface and to the UPF by means of the NG-U interface.

A protocol structure between network entities described above is described. On the system of FIG. 1 and/or FIG. 2, layers of a radio interface protocol between the UE and the network (e.g. NG-RAN and/or E-UTRAN) may be classified into a first layer (L1), a second layer (L2), and a third layer (L3) based on the lower three layers of the open system interconnection (OSI) model that is well-known in the communication system.

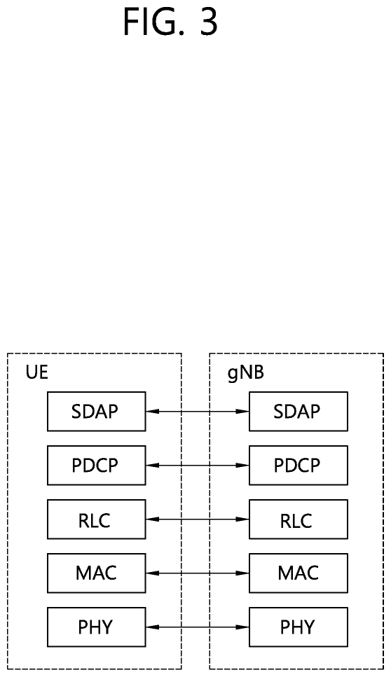

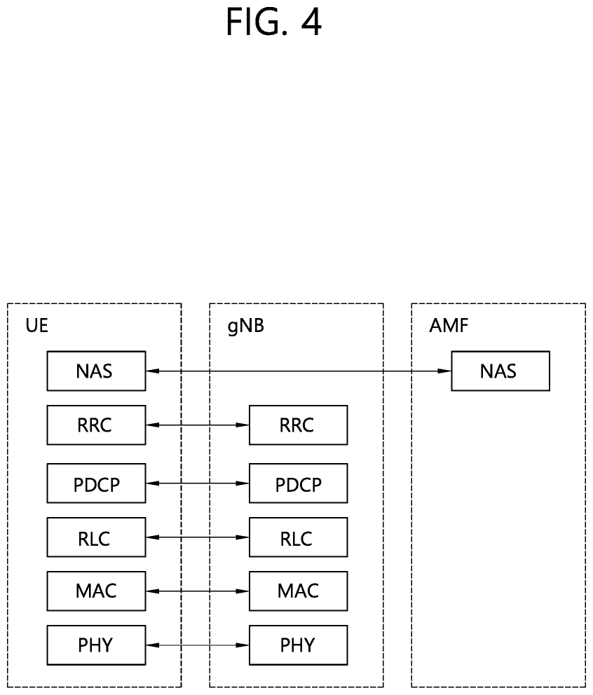

FIG. 3 shows a block diagram of a user plane protocol stack to which the technical features of the present invention can be applied. FIG. 4 shows a block diagram of a control plane protocol stack to which the technical features of the present invention can be applied. The user/control plane protocol stacks shown in FIG. 3 and FIG. 4 are used in NR. However, user/control plane protocol stacks shown in FIG. 3 and FIG. 4 may be used in LTE/LTE-A without loss of generality, by replacing gNB/AMF with eNB/MME.

Referring to FIG. 3 and FIG. 4, a physical (PHY) layer belonging to L1. The PHY layer offers information transfer services to media access control (MAC) sublayer and higher layers. The PHY layer offers to the MAC sublayer transport channels. Data between the MAC sublayer and the PHY layer is transferred via the transport channels. Between different PHY layers, i.e., between a PHY layer of a transmission side and a PHY layer of a reception side, data is transferred via the physical channels.

The MAC sublayer belongs to L2. The main services and functions of the MAC sublayer include mapping between logical channels and transport channels, multiplexing/de-multiplexing of MAC service data units (SDUs) belonging to one or different logical channels into/from transport blocks (TB) delivered to/from the physical layer on transport channels, scheduling information reporting, error correction through hybrid automatic repeat request (HARQ), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e. transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

The service data adaptation protocol (SDAP) sublayer belong to L2. The SDAP sublayer is only defined in the user plane. The SDAP sublayer is only defined for NR. The main services and functions of SDAP include, mapping between a QoS flow and a data radio bearer (DRB), and marking QoS flow ID (QFI) in both DL and UL packets. The SDAP sublayer offers to 5GC QoS flows.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions, QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signaling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the BS.

In RRC_CONNECTED, the UE has an RRC connection with the network (i.e. E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_IDLE may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC_INACTIVE. Meanwhile, in RRC_INACTIVE, 5GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

The physical channels may be modulated according to OFDM processing and utilizes time and frequency as radio resources. The physical channels consist of a plurality of orthogonal frequency division multiplexing (OFDM) symbols in time domain and a plurality of subcarriers in frequency domain. One subframe consists of a plurality of OFDM symbols in the time domain. A resource block is a resource allocation unit, and consists of a plurality of OFDM symbols and a plurality of subcarriers. In addition, each subframe may use specific subcarriers of specific OFDM symbols (e.g. first OFDM symbol) of the corresponding subframe for a physical downlink control channel (PDCCH), i.e. L1/L2 control channel. A transmission time interval (TTI) is a basic unit of time used by a scheduler for resource allocation. The TTI may be defined in units of one or a plurality of slots, or may be defined in units of mini-slots.

The transport channels are classified according to how and with what characteristics data are transferred over the radio interface. DL transport channels include a broadcast channel (BCH) used for transmitting system information, a downlink shared channel (DL-SCH) used for transmitting user traffic or control signals, and a paging channel (PCH) used for paging a UE. UL transport channels include an uplink shared channel (UL-SCH) for transmitting user traffic or control signals and a random access channel (RACH) normally used for initial access to a cell.

Different kinds of data transfer services are offered by MAC sublayer. Each logical channel type is defined by what type of information is transferred. Logical channels are classified into two groups: control channels and traffic channels.

Control channels are used for the transfer of control plane information only. The control channels include a broadcast control channel (BCCH), a paging control channel (PCCH), a common control channel (CCCH) and a dedicated control channel (DCCH). The BCCH is a DL channel for broadcasting system control information. The PCCH is DL channel that transfers paging information, system information change notifications. The CCCH is a channel for transmitting control information between UEs and network. This channel is used for UEs having no RRC connection with the network. The DCCH is a point-to-point bi-directional channel that transmits dedicated control information between a UE and the network. This channel is used by UEs having an RRC connection.

Traffic channels are used for the transfer of user plane information only. The traffic channels include a dedicated traffic channel (DTCH). The DTCH is a point-to-point channel, dedicated to one UE, for the transfer of user information. The DTCH can exist in both UL and DL.

Regarding mapping between the logical channels and transport channels, in DL, BCCH can be mapped to BCH, BCCH can be mapped to DL-SCH, PCCH can be mapped to PCH, CCCH can be mapped to DL-SCH, DCCH can be mapped to DL-SCH, and DTCH can be mapped to DL-SCH. In UL, CCCH can be mapped to UL-SCH, DCCH can be mapped to UL-SCH, and DTCH can be mapped to UL-SCH.

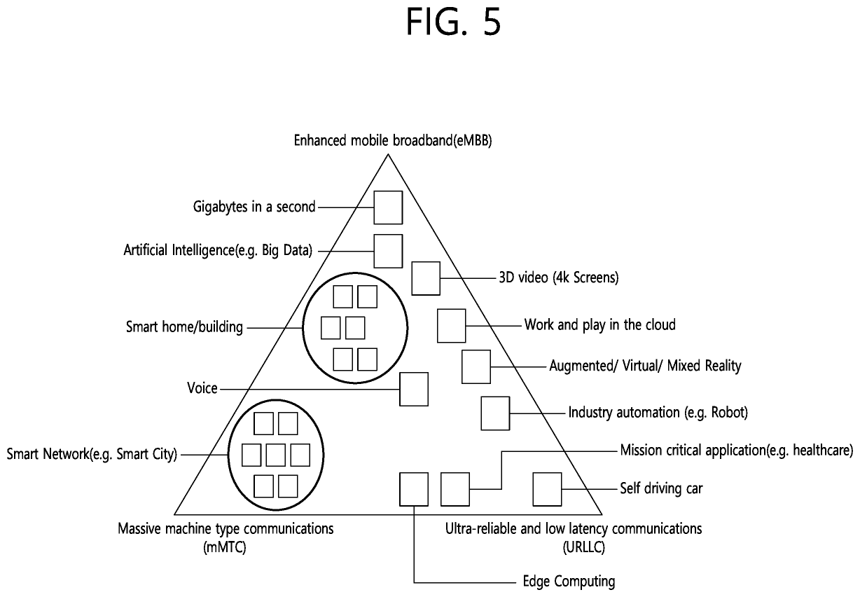

FIG. 5 shows examples of 5G usage scenarios to which the technical features of the present invention can be applied. The 5G usage scenarios shown in FIG. 5 are only exemplary, and the technical features of the present invention can be applied to other 5G usage scenarios which are not shown in FIG. 5.

Referring to FIG. 5, the three main requirements areas of 5G include (1) enhanced mobile broadband (eMBB) domain, (2) massive machine type communication (mMTC) area, and (3) ultra-reliable and low latency communications (URLLC) area. Some use cases may require multiple areas for optimization and, other use cases may only focus on only one key performance indicator (KPI). 5G is to support these various use cases in a flexible and reliable way.

eMBB focuses on across-the-board enhancements to the data rate, latency, user density, capacity and coverage of mobile broadband access. The eMBB aims ˜10 Gbps of throughput. eMBB far surpasses basic mobile Internet access and covers rich interactive work and media and entertainment applications in cloud and/or augmented reality. Data is one of the key drivers of 5G and may not be able to see dedicated voice services for the first time in the 5G era. In 5G, the voice is expected to be processed as an application simply using the data connection provided by the communication system. The main reason for the increased volume of traffic is an increase in the size of the content and an increase in the number of applications requiring high data rates. Streaming services (audio and video), interactive video and mobile Internet connectivity will become more common as more devices connect to the Internet. Many of these applications require always-on connectivity to push real-time information and notifications to the user. Cloud storage and applications are growing rapidly in mobile communication platforms, which can be applied to both work and entertainment. Cloud storage is a special use case that drives growth of uplink data rate. 5G is also used for remote tasks on the cloud and requires much lower end-to-end delay to maintain a good user experience when the tactile interface is used. In entertainment, for example, cloud games and video streaming are another key factor that increases the demand for mobile broadband capabilities. Entertainment is essential in smartphones and tablets anywhere, including high mobility environments such as trains, cars and airplanes. Another use case is augmented reality and information retrieval for entertainment. Here, augmented reality requires very low latency and instantaneous data amount.

mMTC is designed to enable communication between devices that are low-cost, massive in number and battery-driven, intended to support applications such as smart metering, logistics, and field and body sensors. mMTC aims ˜10 years on battery and/or ˜1 million devices/km2. mMTC allows seamless integration of embedded sensors in all areas and is one of the most widely used 5G applications. Potentially by 2020, IoT devices are expected to reach 20.4 billion. Industrial IoT is one of the areas where 5G plays a key role in enabling smart cities, asset tracking, smart utilities, agriculture and security infrastructures.

URLLC will make it possible for devices and machines to communicate with ultra-reliability, very low latency and high availability, making it ideal for vehicular communication, industrial control, factory automation, remote surgery, smart grids and public safety applications. URLLC aims ˜1 ms of latency. URLLC includes new services that will change the industry through links with ultra-reliability/low latency, such as remote control of key infrastructure and self-driving vehicles. The level of reliability and latency is essential for smart grid control, industrial automation, robotics, drones control and coordination.

Next, a plurality of use cases included in the triangle of FIG. X will be described in more detail.

5G can complement fiber-to-the-home (FTTH) and cable-based broadband (or DOCSIS) as a means of delivering streams rated from hundreds of megabits per second to gigabits per second. This high speed can be required to deliver TVs with resolutions of 4K or more (6K, 8K and above) as well as virtual reality (VR) and augmented reality (AR). VR and AR applications include mostly immersive sporting events. Certain applications may require special network settings. For example, in the case of a VR game, a game company may need to integrate a core server with an edge network server of a network operator to minimize delay.

Automotive is expected to become an important new driver for 5G, with many use cases for mobile communications to vehicles. For example, entertainment for passengers demands high capacity and high mobile broadband at the same time. This is because future users will continue to expect high-quality connections regardless of their location and speed. Another use case in the automotive sector is an augmented reality dashboard. The driver can identify an object in the dark on top of what is being viewed through the front window through the augmented reality dashboard. The augmented reality dashboard displays information that will inform the driver about the object's distance and movement. In the future, the wireless module enables communication between vehicles, information exchange between the vehicle and the supporting infrastructure, and information exchange between the vehicle and other connected devices (e.g. devices accompanied by a pedestrian). The safety system allows the driver to guide the alternative course of action so that he can drive more safely, thereby reducing the risk of accidents. The next step will be a remotely controlled vehicle or self-driving vehicle. This requires a very reliable and very fast communication between different self-driving vehicles and between vehicles and infrastructure. In the future, a self-driving vehicle will perform all driving activities, and the driver will focus only on traffic that the vehicle itself cannot identify. The technical requirements of self-driving vehicles require ultra-low latency and high-speed reliability to increase traffic safety to a level not achievable by humans.

Smart cities and smart homes, which are referred to as smart societies, will be embedded in high density wireless sensor networks. The distributed network of intelligent sensors will identify conditions for cost and energy-efficient maintenance of a city or house. A similar setting can be performed for each home. Temperature sensors, windows and heating controllers, burglar alarms and appliances are all wirelessly connected. Many of these sensors typically require low data rate, low power and low cost. However, for example, real-time HD video may be required for certain types of devices for monitoring.

The consumption and distribution of energy, including heat or gas, is highly dispersed, requiring automated control of distributed sensor networks. The smart grid interconnects these sensors using digital information and communication technologies to collect and act on information. This information can include supplier and consumer behavior, allowing the smart grid to improve the distribution of fuel, such as electricity, in terms of efficiency, reliability, economy, production sustainability, and automated methods. The smart grid can be viewed as another sensor network with low latency.

The health sector has many applications that can benefit from mobile communications. Communication systems can support telemedicine to provide clinical care in remote locations. This can help to reduce barriers to distance and improve access to health services that are not continuously available in distant rural areas. It is also used to save lives in critical care and emergency situations. Mobile communication based wireless sensor networks can provide remote monitoring and sensors for parameters such as heart rate and blood pressure.

Wireless and mobile communications are becoming increasingly important in industrial applications. Wiring costs are high for installation and maintenance. Thus, the possibility of replacing a cable with a wireless link that can be reconfigured is an attractive opportunity in many industries. However, achieving this requires that wireless connections operate with similar delay, reliability, and capacity as cables and that their management is simplified. Low latency and very low error probabilities are new requirements that need to be connected to 5G.

Logistics and freight tracking are important use cases of mobile communications that enable tracking of inventory and packages anywhere using location based information systems. Use cases of logistics and freight tracking typically require low data rates, but require a large range and reliable location information.

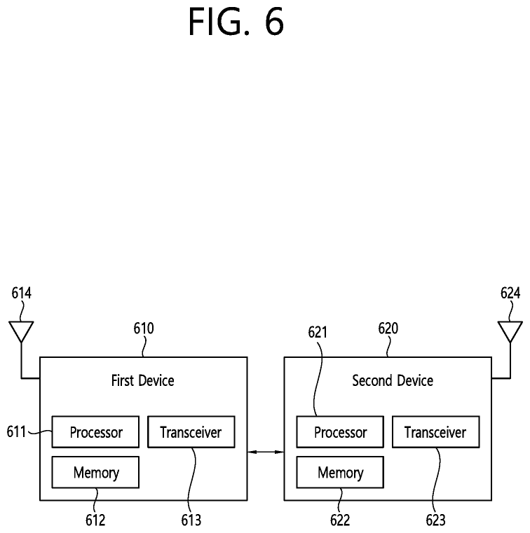

FIG. 6 shows an example of a wireless communication system to which the technical features of the present invention can be applied.

Referring to FIG. 6, the wireless communication system may include a first device 610 and a second device 620.

The first device 610 includes a base station, a network node, a transmitting UE, a receiving UE, a wireless device, a wireless communication device, a vehicle, a vehicle equipped with an autonomous driving function, a connected car, a drone, an unmanned aerial vehicle (UAV), an artificial intelligence (AI) module, a robot, an augmented reality (AR) device, a virtual reality (VR) device, a mixed reality (MR) device, a hologram device, a public safety device, an MTC device, an internet-of-things (IoT) device, a medical device, a fin-tech device (or, a financial device), a security device, a climate/environmental device, a device related to 5G services, or a device related to the fourth industrial revolution.

The second device 620 includes a base station, a network node, a transmitting UE, a receiving UE, a wireless device, a wireless communication device, a vehicle, a vehicle equipped with an autonomous driving function, a connected car, a drone, a UAV, an AI module, a robot, an AR device, a VR device, an MR device, a hologram device, a public safety device, an MTC device, an IoT device, a medical device, a fin-tech device (or, a financial device), a security device, a climate/environmental device, a device related to 5G services, or a device related to the fourth industrial revolution.

For example, the UE may include a mobile phone, a smart phone, a laptop computer, a digital broadcasting terminal, a personal digital assistant (PDA), a portable multimedia player (PMP), a navigation device, a slate personal computer (PC), a tablet PC, an ultrabook, a wearable device (e.g. a smartwatch, a smart glass, a head mounted display (HMD)). For example, the HMD may be a display device worn on the head. For example, the HMD may be used to implement AR, VR and/or MR.

For example, the drone may be a flying object that is flying by a radio control signal without a person boarding it. For example, the VR device may include a device that implements an object or background in the virtual world. For example, the AR device may include a device that implements connection of an object and/or a background of a virtual world to an object and/or a background of the real world. For example, the MR device may include a device that implements fusion of an object and/or a background of a virtual world to an object and/or a background of the real world. For example, the hologram device may include a device that implements a 360-degree stereoscopic image by recording and playing stereoscopic information by utilizing a phenomenon of interference of light generated by the two laser lights meeting with each other, called holography. For example, the public safety device may include a video relay device or a video device that can be worn by the user's body. For example, the MTC device and the IoT device may be a device that do not require direct human intervention or manipulation. For example, the MTC device and the IoT device may include a smart meter, a vending machine, a thermometer, a smart bulb, a door lock and/or various sensors. For example, the medical device may be a device used for the purpose of diagnosing, treating, alleviating, handling, or preventing a disease. For example, the medical device may be a device used for the purpose of diagnosing, treating, alleviating, or correcting an injury or disorder. For example, the medical device may be a device used for the purpose of inspecting, replacing or modifying a structure or function. For example, the medical device may be a device used for the purpose of controlling pregnancy. For example, the medical device may include a treatment device, a surgical device, an (in vitro) diagnostic device, a hearing aid and/or a procedural device, etc. For example, a security device may be a device installed to prevent the risk that may occur and to maintain safety. For example, the security device may include a camera, a closed-circuit TV (CCTV), a recorder, or a black box. For example, the fin-tech device may be a device capable of providing financial services such as mobile payment. For example, the fin-tech device may include a payment device or a point of sales (POS). For example, the climate/environmental device may include a device for monitoring or predicting the climate/environment.

The first device 610 may include at least one or more processors, such as a processor 611, at least one memory, such as a memory 612, and at least one transceiver, such as a transceiver 613. The processor 611 may perform the functions, procedures, and/or methods of the present invention described below. The processor 611 may perform one or more protocols. For example, the processor 611 may perform one or more layers of the air interface protocol. The memory 612 is connected to the processor 611 and may store various types of information and/or instructions. The transceiver 613 is connected to the processor 611 and may be controlled to transmit and receive wireless signals.

The second device 620 may include at least one or more processors, such as a processor 621, at least one memory, such as a memory 622, and at least one transceiver, such as a transceiver 623. The processor 621 may perform the functions, procedures, and/or methods of the present invention described below. The processor 621 may perform one or more protocols. For example, the processor 621 may perform one or more layers of the air interface protocol. The memory 622 is connected to the processor 621 and may store various types of information and/or instructions. The transceiver 623 is connected to the processor 621 and may be controlled to transmit and receive wireless signals.

The memory 612, 622 may be connected internally or externally to the processor 611, 612, or may be connected to other processors via a variety of technologies such as wired or wireless connections.

The first device 610 and/or the second device 620 may have more than one antenna. For example, antenna 614 and/or antenna 624 may be configured to transmit and receive wireless signals.

Measurement rules for cell re-selection in RRC_IDLE/RRC_INACTIVE is described. It may be referred to as Section 5.2.4.2 of 3GPP TS 36.304 V14.6.0 (2018 March).

When evaluating Srxlev and Squal of non-serving cells for reselection purposes, the UE shall use parameters provided by the serving cell.

Following rules are used by the UE to limit needed measurements:

1> If the serving cell fulfils Srxlev>S_{IntraSearchP} and Squal>S_{IntraSearchQ}, the UE may choose not to perform intra-frequency measurements.

1> Otherwise, the UE shall perform intra-frequency measurements.

1> The UE shall apply the following rules for E-UTRAN inter-frequencies and inter-RAT frequencies which are indicated in system information and for which the UE has priority:

2> For an E-UTRAN inter-frequency or inter-RAT frequency with a reselection priority higher than the reselection priority of the current E-UTRA frequency the UE shall perform measurements of higher priority E-UTRAN inter-frequency or inter-RAT frequencies.

2> For an E-UTRAN inter-frequency with an equal or lower reselection priority than the reselection priority of the current E-UTRA frequency and for inter-RAT frequency with lower reselection priority than the reselection priority of the current E-UTRAN frequency:

3> If the serving cell fulfils Srxlev>S_{nonIntraSearchP} and Squal>S_{nonIntraSearchQ}, the UE may choose not to perform measurements of E-UTRAN inter-frequencies or inter-RAT frequency cells of equal or lower priority unless the UE is triggered to measure an E-UTRAN inter-frequency which is configured with redistributionInterFreqInfo.

3> Otherwise, the UE shall perform measurements of E-UTRAN inter-frequencies or inter-RAT frequency cells of equal or lower priority.

1> If the UE supports relaxed monitoring and s-SearchDeltaP is present in SystemInformationBlockType3, the UE may further limit the needed measurements.

Performing measurements is described. It may be referred to as Section 5.5.3.1 of 3GPP TS 36.304 V14.6.2 (2018 April).

For all measurements, except for UE Rx-Tx time difference measurements, received signal strength indicator (RSSI), UL PDCP packet delay per QoS class identifier (QCI) measurement, channel occupancy measurements, channel busy ratio (CBR) measurement, and except for WLAN measurements of band, carrier info, available admission capacity, backhaul bandwidth, channel utilization, and station count, the UE applies the layer 3 filtering, before using the measured results for evaluation of reporting criteria or for measurement reporting.

The UE shall:

1> whenever the UE has a measConfig, perform reference signal received power (RSRP) and reference signal received quality (RSRQ) measurements for each serving cell as follows:

2> for the primary cell (PCell), apply the time domain measurement resource restriction in accordance with measSubframePatternPCell, if configured;

2> if the UE supports cell-specific reference signal (CRS) based discovery signals measurement:

3> for each secondary cell (SCell) in deactivated state, apply the discovery signals measurement timing configuration in accordance with measDS-Config, if configured within the measObject corresponding to the frequency of the SCell;

1> if the UE has a measConfig with rs-sinr-Config configured, perform reference signal-signal to noise and interference ratio (RS-SINR) (as indicated in the associated reportConfig) measurements as follows:

2> perform the corresponding measurements on the frequency indicated in the associated measObject using available idle periods or using autonomous gaps as necessary;

1> for each measId included in the measIdList within VarMeasConfig:

2> if the purpose for the associated reportConfig is set to reportCGI:

3> if si-RequestForHO is configured for the associated reportConfig:

4> perform the corresponding measurements on the frequency and RAT indicated in the associated measObject using autonomous gaps as necessary;

3> else:

4> perform the corresponding measurements on the frequency and RAT indicated in the associated measObject using available idle periods or using autonomous gaps as necessary;

3> try to acquire the global cell identity of the cell indicated by the cellForWhichToReportCGI in the associated measObject by acquiring the relevant system information from the concerned cell;

3> if an entry in the cellAccessRelatedInfoList includes the selected PLMN, acquire the relevant system information from the concerned cell;

3> if the cell indicated by the cellForWhichToReportCGI included in the associated measObject is an E-UTRAN cell:

4> try to acquire the closed subscriber group (CSG) identity, if the CSG identity is broadcast in the concerned cell;

4> try to acquire the trackingAreaCode in the concerned cell;

4> try to acquire the list of additional PLMN Identities, as included in the plmn-IdentityList, if multiple PLMN identities are broadcast in the concerned cell;

4> if cellAccessRelatedInfoList is included, use trackingAreaCode and plmn-IdentityList from the entry of cellAccessRelatedInfoList containing the selected PLMN;

4> if the includeMultiBandInfo is configured:

5> try to acquire the freqBandIndicator in the SystemInformationBlockType1 of the concerned cell;

5> try to acquire the list of additional frequency band indicators, as included in the multiBandInfoList, if multiple frequency band indicators are included in the SystemInformationBlockType1 of the concerned cell;

5> try to acquire the freqBandIndicatorPriority, if the freqBandIndicatorPriority is included in the SystemInformationBlockType1 of the concerned cell;

3> if the cell indicated by the cellForWhichToReportCGI included in the associated measObject is a UTRAN cell:

4> try to acquire the location area code (LAC), the routing area code (RAC) and the list of additional PLMN Identities, if multiple PLMN identities are broadcast in the concerned cell;

4> try to acquire the CSG identity, if the CSG identity is broadcast in the concerned cell;

3> if the cell indicated by the cellForWhichToReportCGI included in the associated measObject is a GERAN cell:

4> try to acquire the RAC in the concerned cell;

3> if the cell indicated by the cellForWhichToReportCGI included in the associated measObject is a CDMA2000 cell and the cdma2000-Type included in the measObject is typeHRPD:

4> try to acquire the Sector ID in the concerned cell;

3> if the cell indicated by the cellForWhichToReportCGI included in the associated measObject is a CDMA2000 cell and the cdma2000-Type included in the measObject is typelXRTT:

4> try to acquire the BASE ID, SID and NID in the concerned cell;

2> if the ul-DelayConfig is configured for the associated reportConfig:

3> ignore the measObject;

3> configure the PDCP layer to perform UL PDCP packet delay per QCI measurement;

2> else:

3> if a measurement gap configuration is setup; or

3> if the UE does not require measurement gaps to perform the concerned measurements:

4> if s-Measure is not configured; or

4> if s-Measure is configured and the PCell RSRP, after layer 3 filtering, is lower than this value; or

4> if the associated measObject concerns NR; or

4> if measDS-Config is configured in the associated measObject:

5> if the UE supports channel state information reference signal (CSI-RS) based discovery signals measurement; and

5> if the eventId in the associated reportConfig is set to eventC1 or eventC2, or if reportStrongestCSI-RSs is included in the associated reportConfig:

6> perform the corresponding measurements of CSI-RS resources on the frequency indicated in the concerned measObject, applying the discovery signals measurement timing configuration in accordance with measDS-Config in the concerned measObject;

6> if reportCRS-Meas is included in the associated reportConfig, perform the corresponding measurements of neighbouring cells on the frequencies indicated in the concerned measObject as follows:

7> for neighbouring cells on the primary frequency, apply the time domain measurement resource restriction in accordance with measSubframePatternConfigNeigh, if configured in the concerned measObject;

7> apply the discovery signals measurement timing configuration in accordance with measDS-Config in the concerned measObject;

5> else:

6> perform the corresponding measurements of neighbouring cells on the frequencies and RATs indicated in the concerned measObject as follows:

7> for neighbouring cells on the primary frequency, apply the time domain measurement resource restriction in accordance with measSubframePatternConfigNeigh, if configured in the concerned measObject;

7> if the UE supports CRS based discovery signals measurement, apply the discovery signals measurement timing configuration in accordance with measDS-Config, if configured in the concerned measObject;

4> if the ue-RxTxTimeDiffPeriodical is configured in the associated reportConfig:

5> perform the UE Rx-Tx time difference measurements on the PCell;

4> if the reportSSTD-Meas is set to true or pSCell in the associated reportConfig:

5> perform SSTD measurements between the PCell and the primary SCell (PSCell);

4> if the measRSSI-ReportConfig is configured in the associated reportConfig:

5> perform the RSSI and channel occupancy measurements on the frequency indicated in the associated measObject;

2> perform the evaluation of reporting criteria;

The UE capable of CBR measurement when configured to transmit non-pedestrian-to-everything (P2X) related V2X sidelink communication shall:

1> if in coverage on the frequency used for V2X sidelink communication transmission; or

1> if the concerned frequency is included in v2x-InterFreqInfoList in RRCConnectionReconfiguration or in v2x-InterFreqInfoList within SystemInformationBlockType21:

2> if the UE is in RRC_IDLE:

3> if the concerned frequency is the camped frequency:

4> perform CBR measurement on the pools in v2x-CommTxPoolNormalCommon and v2x-CommTxPoolExceptional if included in SystemInformationBlockType21;

3> else if v2x-CommTxPoolNormal or v2x-CommTxPoolExceptional is included in v2x-InterFreqInfoList for the concerned frequency within SystemInformationBlockType21:

4> perform CBR measurement on pools in v2x-CommTxPoolNormal and v2x-CommTxPoolExceptional in v2x-InterFreqInfoList for the concerned frequency in SystemInformationBlockType21;

3> else if the concerned frequency broadcasts SystemInformationBlockType21:

4> perform CBR measurement on pools in v2x-CommTxPoolNormalCommon and v2x-CommTxPoolExceptional if included in SystemInformationBlockType21 broadcast on the concerned frequency;

2> if the UE is in RRC_CONNECTED:

3> if tx-ResourcePoolToAddList is included in VarMeasConfig:

4> perform CBR measurements on each resource pool indicated in tx-ResourcePoolToAddList;

3> if the concerned frequency is the PCell's frequency:

4> perform CBR measurement on the pools in v2x-CommTxPoolNormalDedicated or v2x-SchedulingPool if included in RRCConnectionReconfiguration, v2x-CommTxPoolExceptional if included in SystemInformationBlockType21 for the concerned frequency and v2x-CommTxPoolExceptional if included in mobilityControlInfoV2X;

3> else if v2x-CommTxPoolNormal, v2x-SchedulingPool or v2x-CommTxPoolExceptional is included in v2x-InterFreqInfoList for the concerned frequency within RRCConnectionReconfiguration:

4> perform CBR measurement on pools in v2x-CommTxPoolNormal, v2x-SchedulingPool, and v2x-CommTxPoolExceptional if included in v2x-InterFreqInfoList for the concerned frequency in RRCConnectionReconfiguration;

3> else if the concerned frequency broadcasts SystemInformationBlockType21:

4> perform CBR measurement on pools in v2x-CommTxPoolNormalCommon and v2x-CommTxPoolExceptional if included in SystemInformationBlockType21 for the concerned frequency;

1> else:

2> perform CBR measurement on pools in v2x-CommTxPoolList in SL-V2X-Preconfiguration for the concerned frequency;

The s-Measure defines when the UE is required to perform measurements. The UE is however allowed to perform measurements also when the PCell RSRP exceeds s-Measure, e.g., to measure cells broadcasting a CSG identity following use of the autonomous search function.

The UE may not perform the WLAN measurements it is configured with e.g. due to connection to another WLAN based on user preferences or due to turning off WLAN.

Barred cell is described. It may be referred to as Section 5.3.1 of 3GPP TS 36.304 V14.6.0 (2018 March).

Cell status and cell reservations are indicated in the SystemInformationBlockType1 message (or SystemInformationBlockType1-BR message or SystemInformationBlockType1-NB message) by means of two fields:
cellBarred (IE type: “barred” or “not barred”): In case of multiple PLMNs indicated in SIB1, this field is common for all PLMNs
cellReservedForOperatorUse (IE type: “reserved” or “not reserved”): In case of multiple PLMNs indicated in SIB1, this field is specified per PLMN.

When cell status is indicated as “not barred” and “not reserved” for operator use, all UEs shall treat this cell as candidate during the cell selection and cell reselection procedures.

When cell status is indicated as “not barred” and “reserved” for operator use for any PLMN,
UEs assigned to access class 11 or 15 operating in their home PLMN (HPLMN)/equivalent HPLMN (EHPLMN) shall treat this cell as candidate during the cell selection and reselection procedures if the field cellReservedForOperatorUse for that PLMN set to “reserved”.
UEs assigned to an access class in the range of 0 to 9, 12 to 14 shall behave as if the cell status is “barred” in case the cell is “reserved for operator use” for the registered PLMN or the selected PLMN.

Access classes 11, 15 are only valid for use in the HPLMN/EHPLMN, and access classes 12, 13, 14 are only valid for use in the home country.

When cell status “barred” is indicated or to be treated as if the cell status is “barred”,

1> The UE is not permitted to select/reselect this cell, not even for emergency calls.

1> The UE shall select another cell according to the following rule:

1> If the cell is to be treated as if the cell status is “barred” due to being unable to acquire the MasterInformationBlock (or MasterinformationBlock-NB), the SystemInformationBlockType1 (or SystemInformationBlockType1-BR message or SystemInformationBlockType1-NB), or the SystemInformationBlockType2 (or SystemInformationBlockType2-NB):

2> the UE may exclude the barred cell as a candidate for cell selection/reselection for up to 300 seconds.

2> the UE may select another cell on the same frequency if the selection criteria are fulfilled.

2> the UE may select the same cell in normal coverage if the UE was barred in the cell due to being unable to acquire MasterInformationBlock, SystemInformationBlockType1-BR, or SystemInformationBlockType2 in enhanced coverage, but was able to acquire MasterInformationBlock, SystemInformationBlockType1, and SystemInformationBlockType2 in normal coverage, if the selection criteria are fulfilled.

1> else

2> If the cell is a CSG cell:

3> the UE may select another cell on the same frequency if the selection/reselection criteria are fulfilled.

2> else

3> If the field intraFreqReselection in field cellAccessRelatedInfo in SystemInformationBlockType1 (or SystemInformationBlockType1-BR message or SystemInformationBlockType1-NB) message is set to “allowed”, the UE may select another cell on the same frequency if re-selection criteria are fulfilled.

4> The UE shall exclude the barred cell as a candidate for cell selection/reselection for 300 seconds.

3> If the field intraFreqReselection in field cellAccessRelatedInfo in SystemInformationBlockType1 (or SystemInformationBlockType1-BR message or SystemInformationBlockType1-NB) message is set to “not allowed” the UE shall not re-select a cell on the same frequency as the barred cell;

4> The UE shall exclude the barred cell and the cells on the same frequency as a candidate for cell selection/reselection for 300 seconds.

The cell selection of another cell may also include a change of RAT.

NR standalone operation on unlicensed bands is being studied. Since a cell on the unlicensed bands can be configured as PCell, a channel occupancy and/or RSSI of the unlicensed bands should be considered as a factor for a measurement rule and/or barring a cell on the unlicensed bands.

Hereinafter, a method for enhancing a measurement rule on an unlicensed frequency/band/spectrum and/or baring access to a cell on an unlicensed frequency/band/spectrum are described according to embodiments of the present invention.

1. Measurement Rule Enhancements

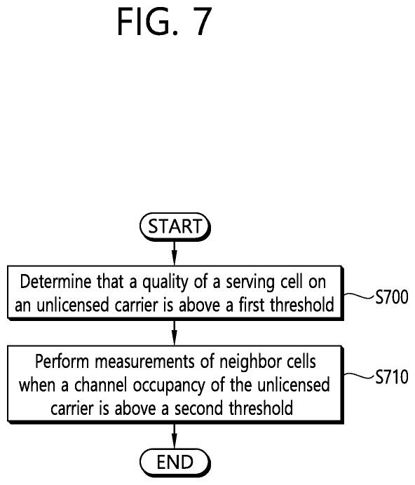

FIG. 7 shows an example of a method for enhancing a measurement rule according to an embodiment of the present invention.

In step S700, the UE determines that a quality of a serving cell on an unlicensed carrier is above a first threshold. In step S710, the UE performs measurements of neighbor cells when a channel occupancy of the unlicensed carrier is above a second threshold.

The UE may be in RRC_CONNECTED. In this case, the quality of the serving cell may be RSRP. The first threshold may be an s-measure which defines when the wireless device is required to perform the measurements.

Alternatively, the UE may be in RRC_IDLE and/or RRC_INACTIVE. In this case, the quality of the serving cell may be one of an RSRP of the serving cell or RSRQ of the serving cell.

The channel occupancy of the unlicensed carrier may be RSSI of the unlicensed carrier.

For UE in RRC_CONNECTED, more detailed operation may be as follows.

For a UE which is connected to a serving cell on unlicensed frequency, even though s-measure is configured and RSRP of the PCell is higher than the configured s-measure value, if RSSI and/or channel occupancy of the unlicensed frequency is higher than RSSI threshold and/or channel occupancy threshold, the UE performs neighbor cell measurement in accordance with measurement configuration. That is,

1> if s-Measure is not configured; or

1> if PCell serving frequency is unlicensed frequency, and

2> if the PCell RSSI, i.e. the measurement result of RSSI of PCell serving frequency, is higher than the RSSI threshold, and/or if the PCell channel occupancy, i.e. the measurement result of channel occupancy of PCell serving frequency, is higher than the channel occupancy threshold; and

2> if s-Measure is configured and the PCell RSRP, after layer 3 filtering, is higher than this value;

3> UE performs the corresponding measurements of neighbouring cells on the frequencies and RATs indicated in the concerned measurement object.

1> else if PCell serving frequency is licensed frequency; and

2> if s-Measure is configured and the PCell RSRP, after layer 3 filtering, is lower than this value;

3> UE performs the corresponding measurements of neighbouring cells on the frequencies and RATs indicated in the concerned measurement object.

For UE in RRC_IDLE and/or RRC_INACTIVE, more detailed operation may be as follows.

For a UE in RRC_IDLE and/or RRC_INACTIVE which is camped on a serving cell on unlicensed frequency, even though the serving cell quality, i.e. RSRP or RSRQ, is higher than threshold 1, i.e. SIntraSearchP or SIntraSearchQ, if RSSI and/or channel occupancy of the serving frequency is higher than RSSI threshold and/or channel occupancy threshold, the UE performs neighbor cell measurement.

That is, for intra-frequency measurements, the UE may choose not to perform intra-frequency measurement if following condition is met:
If the serving cell fulfils Srxlev>S_{IntraSearchP} and Squal>S_{IntraSearchQ}, and if RSSI of the serving frequency is lower than RSSI threshold and/or channel occupancy of the serving frequency is lower than the channel occupancy threshold.

Otherwise, the UE shall perform intra-frequency measurements.

For inter-frequency measurements, the UE may choose not to perform measurements of inter-frequency of equal or lower priority if following condition is met:
If the serving cell fulfils Srxlev>S_{nonIntraSearchP} and Squal>S_{nonIntraSearchQ}, and if RSSI of the serving frequency is lower than RSSI threshold and/or channel occupancy of the serving frequency is lower than the channel occupancy threshold.

Otherwise, the UE shall perform measurements of inter-frequency of equal or lower priority.

According to embodiment of the present invention shown in FIG. 7, the measurement rule can be enhanced so that the UE is able to decide whether to perform the neighbor cell measurements depending on how the serving unlicensed frequency is busy. No matter how good the PCell quality is, if the channel is busy, the cell on the unlicensed frequency cannot be a good cell due to the nature of the unlicensed frequency. Therefore, even though the serving cell quality is good enough, the UE needs to measure and find better neighbor cell, if the serving frequency is busy.

2. Barring Based on Channel Busy Ratio

If the RSSI of an unlicensed frequency is higher than the RSSI threshold, and/or if the channel occupancy of an unlicensed frequency is higher than the channel occupancy threshold, the UE may treat all cells on the unlicensed frequency as if the cell status is “barred” during a period of barring time, e.g. 300 s. The RSSI threshold and/or the channel occupancy threshold may be provided by the network via broadcast signaling, e.g. system information. The barring time may also be configured by the network via broadcast signaling, e.g. system information.

During the barring time, i.e. while the UE considers all cells on the unlicensed frequency as “barred”, the UE may not perform RSSI measurements and/or channel occupancy measurement for the unlicensed frequency. After the barring time, the UE may resume RSSI measurements and/or channel occupancy measurement for the unlicensed frequency.

If the UE performs RSSI measurements and/or channel occupancy measurement for the unlicensed frequency while the UE considers all cells on the unlicensed frequency as “barred”, and if the RSSI of the unlicensed frequency is lower than the RSSI threshold, and/or If the channel occupancy of the unlicensed frequency is lower than the channel occupancy threshold, the UE may treat all cells on the unlicensed frequency as if the cell status is not “barred”.

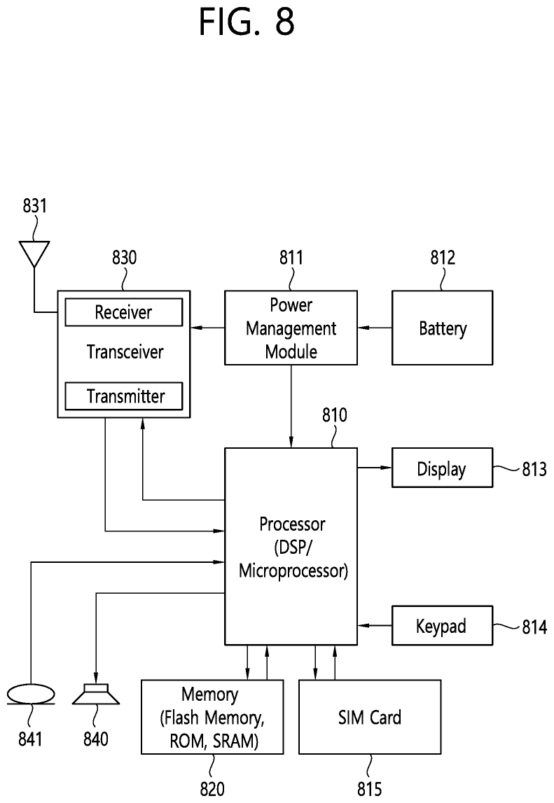

FIG. 8 shows a UE to implement an embodiment of the present invention. The present invention described above for UE side may be applied to this embodiment.

A UE includes a processor 810, a power management module 811, a battery 812, a display 813, a keypad 814, a subscriber identification module (SIM) card 815, a memory 820, a transceiver 830, one or more antennas 831, a speaker 840, and a microphone 841.

The processor 810 may be configured to implement proposed functions, procedures and/or methods described in this description. Layers of the radio interface protocol may be implemented in the processor 810. The processor 810 may include application-specific integrated circuit (ASIC), other chipset, logic circuit and/or data processing device. The processor 810 may be an application processor (AP). The processor 810 may include at least one of a digital signal processor (DSP), a central processing unit (CPU), a graphics processing unit (GPU), a modem (modulator and demodulator). An example of the processor 810 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The processor 810 may be configured to determine that a quality of a serving cell on an unlicensed carrier is above a first threshold. The processor 810 may be configured to perform measurements of neighbor cells when a channel occupancy of the unlicensed carrier is above a second threshold.

The UE may be in RRC_CONNECTED. In this case, the quality of the serving cell may be RSRP. The first threshold may be an s-measure which defines when the wireless device is required to perform the measurements.

Alternatively, the UE may be in RRC_IDLE and/or RRC_INACTIVE. In this case, the quality of the serving cell may be one of an RSRP of the serving cell or RSRQ of the serving cell.

The channel occupancy of the unlicensed carrier may be RSSI of the unlicensed carrier.

The power management module 811 manages power for the processor 810 and/or the transceiver 830. The battery 812 supplies power to the power management module 811. The display 813 outputs results processed by the processor 810. The keypad 814 receives inputs to be used by the processor 810. The keypad 814 may be shown on the display 813. The SIM card 815 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The memory 820 is operatively coupled with the processor 810 and stores a variety of information to operate the processor 810. The memory 820 may include read-only memory (ROM), random access memory (RAM), flash memory, memory card, storage medium and/or other storage device. When the embodiments are implemented in software, the techniques described herein can be implemented with modules (e.g., procedures, functions, and so on) that perform the functions described herein. The modules can be stored in the memory 820 and executed by the processor 810. The memory 820 can be implemented within the processor 810 or external to the processor 810 in which case those can be communicatively coupled to the processor 810 via various means as is known in the art.

The transceiver 830 is operatively coupled with the processor 810, and transmits and/or receives a radio signal. The transceiver 830 includes a transmitter and a receiver. The transceiver 830 may include baseband circuitry to process radio frequency signals. The transceiver 830 controls the one or more antennas 831 to transmit and/or receive a radio signal.

The speaker 840 outputs sound-related results processed by the processor 810. The microphone 841 receives sound-related inputs to be used by the processor 810.

According to embodiment of the present invention shown in FIG. 8, the measurement rule can be enhanced so that the UE is able to decide whether to perform the neighbor cell measurements depending on how the serving unlicensed frequency is busy. No matter how good the PCell quality is, if the channel is busy, the cell on the unlicensed frequency cannot be a good cell due to the nature of the unlicensed frequency. Therefore, even though the serving cell quality is good enough, the UE needs to measure and find better neighbor cell, if the serving frequency is busy.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

What is claimed is:

1. A method performed by a wireless device in a wireless communication system, the method comprising:
determining that a quality of a serving cell on an unlicensed carrier is above a first threshold; and
performing measurements of neighbor cells when a channel occupancy of the unlicensed carrier is above a second threshold.

2. The method of claim 1, wherein the wireless device is in a radio resource control (RRC) connected mode.

3. The method of claim 2, wherein the quality of the serving cell is a reference signal received power (RSRP) of the serving cell.

4. The method of claim 2, wherein the first threshold is an s-measure which defines when the wireless device is required to perform the measurements.

5. The method of claim 1, wherein the wireless device is in a radio resource control (RRC) idle mode and/or an RRC inactive mode.

6. The method of claim 5, wherein the quality of the serving cell is one of an RSRP of the serving cell or a reference signal received quality (RSRQ) of the serving cell.

7. The method of claim 1, wherein the channel occupancy of the unlicensed carrier is a received signal strength indicator (RSSI) of the unlicensed carrier.

8. The method of claim 1, wherein the wireless device is in communication with at least one of a user equipment, a network, and/or autonomous vehicles other than the wireless device.

9. A wireless device in a wireless communication system, the wireless device comprising:
a memory;
a transceiver; and
a processor, operably coupled to the memory and the transceiver, and configured to:
determine that a quality of a serving cell on an unlicensed carrier is above a first threshold, and
perform measurements of neighbor cells when a channel occupancy of the unlicensed carrier is above a second threshold.

10. The wireless device of claim 9, wherein the wireless device is in a radio resource control (RRC) connected mode.

11. The wireless device of claim 10, wherein the quality of the serving cell is one of a reference signal received power (RSRP).

12. The wireless device of claim 10, wherein the first threshold is an s-measure which defines when the wireless device is required to perform the measurements.

13. The wireless device of claim 9, wherein the wireless device is in a radio resource control (RRC) idle mode and/or an RRC inactive mode, and
wherein the quality of the serving cell is one of an RSRP of the serving cell or a reference signal received quality (RSRQ) of the serving cell.

14. The wireless device of claim 9, wherein the channel occupancy of the unlicensed carrier is a received signal strength indicator (RSSI) of the unlicensed carrier.

15. A processor for a wireless device in a wireless communication system, wherein the processor is configured to:
determine that a quality of a serving cell on an unlicensed carrier is above a first threshold, and
perform measurements of neighbor cells when a channel occupancy of the unlicensed carrier is above a second threshold.
